(19) United States
(12) Patent Application Publication
(10) Pub. No.: US 2009/0106774 A1
(43) Pub. Date: Apr. 23, 2009

(54) INTERPROCESS COMMUNICATION SYSTEM, INTERPROCESS COMMUNICATION CONTROL DEVICE, INTERPROCESS COMMUNICATION CONTROL METHOD, AND COMPUTER PROGRAM PRODUCT

(75) Inventor: Hiroyuki SESHIMO, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/249,686

(22) Filed: Oct. 10, 2008

(30) Foreign Application Priority Data
Oct. 17, 2007 (JP) 2007-265261

(51) Int. Cl. G06F 13/00

(52) U.S. Cl. 719/313

(57) ABSTRACT

An interprocess communication system comprising: a transmission device; and a reception device connected to the transmission device so as to be able to receive communication data via a network, wherein in the transmission device, a first process, to which a first thread and a plurality of other threads belong, is created, the first thread performing interprocess communication with outside and the plurality of other threads transferring the communication data to the first thread, in the reception device, a second process, to which a second thread and a plurality of other threads belong, is created, the second thread performing interprocess communication with outside and the plurality of other threads receiving the communication data transferred from the second thread, and the first thread transmits, to the second thread, the communication data containing information for identifying a destination thread, is disclosed. An interprocess communication control device and method are also disclosed.

### FIELD OF THE INVENTION

The present invention relates to an interprocess communication system, an interprocess communication control device, an interprocess communication control method and a computer program product.

### BACKGROUND

In general, when a computer executes programs, there is a case where it is necessary to exchange data between a plurality of programs which are being executed at the same time. Usually, data exchange between programs being executed is performed by interprocess communication using sockets, pipes, shared memory and the like.

For example, Japanese Laid-Open patent Publication No. 11-120009 discloses that a communication control server process is provided as a special process for controlling interprocess communication. By collectively receiving, with the communication control server process, messages from a client process and analyzing contents of the messages, the messages can be securely transmitted to another client process that is a transmission destination of the messages.

Further, in the case where interprocess communication is performed between processes to each of which a plurality of threads belong, in a process for transmitting communication data, data to be communicated is transferred to a specific thread, which is created for performing transmission to an external process, from another thread, and then communication data is generated and transmitted to a predetermined process which is a transmission destination. Also, in a process for receiving communication data, communication data is received by a specific thread created for performing reception from an external process, and a content of the communication data is analyzed, whereby necessary data is transferred from-the specific thread to a predetermined thread belonging to the same process as that of the specific thread.

However, in the interprocess communication disclosed in the Japanese Laid-Open Patent Publication No. 11-120009, in the case of updating communication specifications and the like of a client process, there is a necessity to also update codes for a corresponding thread and a corresponding communication control server process. Therefore, updating is also performed on a communication control program whose module is relatively complex, and this causes a problem in that not only man-hours are increased but also that probability of a bug occurring due to a correction in updating is increased.

The above problem is similarly caused in the case where interprocess communication is performed between processes to each of which a plurality of threads belong. To be specific, in the case where communication specifications and the like for communication to a thread belonging to a different process are updated for a different thread from a thread directly used for the interprocess communication, it is necessary that a program code is updated not only for the different thread but also for the thread directly used for the interprocess communication, and possibly necessary that a process information table to which the different thread refers is also updated. Accordingly, this causes the same problem in that man-hours for program updating are increased and that probability of a bug occurring due to a correction in updating is increased.

### SUMMARY OF THE INVENTION

The scope of the present invention is defined solely by the appended claims, and is not affected to any degree by the statements within this summary.

A first aspect of the present invention is an interprocess communication system for performing interprocess communication, comprising: a transmission device; and a reception device connected to the transmission device so as to be able to receive communication data via a network, wherein in the transmission device, a first process, to which a first thread and a plurality of other threads belong, is created, the first thread performing interprocess communication with outside and the plurality of other threads transferring the communication data to the first thread, in the reception device, a second process, to which a second thread and a plurality of other threads belong, is created, the second thread performing interprocess communication with outside and the plurality of other threads receiving the communication data transferred from the second thread, and the first thread transmits, to the second thread, the communication data containing information for identifying a destination thread.

A second aspect of the present invention is an interprocess communication control device operable to transmit/receive communication data by interprocess communication, the interprocess communication control device comprising a memory under control of a processor, the memory storing instructions enabling the processor to carry out operations comprising: creating a first process to which a first thread and a plurality of other threads belong, the first thread transmitting the communication data to another process by interprocess communication and the plurality of other threads transferring the communication data to the first thread; and creating a second process to which a second thread and a plurality of other threads belong, the second thread receiving the communication data from another process by interprocess communication and the plurality of other threads receiving the communication data transferred from the second thread, wherein the first thread transmits, to the second thread, the communication data containing information for identifying a destination thread.

A third aspect of the present invention is an interprocess communication control method operable to transmit/receive communication data by interprocess communication, the interprocess communication control method comprising: transmitting the communication data from a first process to a second process, the first process having a first thread and a plurality of other threads belonging thereto, the first thread performing data transmission to another process by interprocess communication and the plurality of other threads transferring the communication data to the first thread, the second process having a second thread and a plurality of other threads belonging thereto, the second thread performing data reception from another process by interprocess communication and the plurality of other threads receiving the communication data transferred from the second thread; and receiving the communication data by the second process, wherein the first thread transmits, to the second thread, the communication data containing information for identifying a destination thread, and the second thread receives the communication data.

A fourth aspect of the present invention is a computer program product storing a computer program executable by a computer operable to transmit/receive communication data by interprocess communication, the computer program product comprising: a computer readable medium; and instructions on the computer readable medium, adapted to enable a general purpose computer to perform operations, comprising: creating a first process to which a first thread and a plurality of other threads belong, the first thread transmitting the communication data to another process by interprocess communication and the plurality of other threads transferring the communication data to the first thread; and creating a second process to which a second thread and a plurality of other threads belong, the second thread receiving the communication data from another process by interprocess communication and the plurality of other threads receiving the communication data transferred from the second thread, wherein the first thread transmits, to the second thread, the communication data containing information for identifying a destination thread.

A fifth aspect of the present invention is a computer program product storing a computer program executable by a computer operable to transmit communication data via a network by interprocess communication, the computer program product comprising: a computer readable medium; and instructions on the computer readable medium, adapted to enable a general purpose computer to perform operations, comprising: creating a predetermined process to which a predetermined thread and a plurality of other threads belong, the predetermined thread transmitting the communication data to another process by interprocess communication and the plurality of other threads transferring the communication data to the predetermined thread; and transmitting, from the predetermined thread to a thread belonging to said another process, the communication data containing information for identifying a destination thread.

### BRIEF DESCRIPTION OF THE DRAWINGS

FIG. 1 is a block diagram showing a configuration of an interprocess communication system according to a first embodiment of the present invention;

FIG. 2 is a block diagram showing a hardware configuration of the interprocess communication system according to the first embodiment of the present invention;

FIG. 3 is a schematic diagram showing a brief structure of a measuring device of an analyzer according to the first embodiment;

FIG. 4 is a schematic diagram for describing settings information obtained by an analogue substrate;

FIG. 5 is a schematic diagram for describing settings information obtained by a waveform signal processing substrate;

FIG. 6 is a schematic diagram showing relationships among threads of the interprocess communication system according to the first embodiment of the present invention;

FIG. 7 is a flowchart showing a sequence of processing performed by a CPU substrate of a PC (transmission device) of the interprocess communication system according to the first embodiment of the present invention;

FIG. 8 is a schematic diagram showing a data structure of communication data transmitted by the interprocess communication system according to the first embodiment of the present invention;

FIG. 9 is a flowchart showing a sequence of processing performed by a CPU substrate of the analyzer (reception device) of the interprocess communication system according to the first embodiment of the present invention;

FIG. 10 is a flowchart showing a sequence of processing performed by the CPU substrate of the analyzer (reception device) in the case where the processing includes determining processing concerning information for identifying a destination thread;

FIG. 11 is a block diagram showing a configuration of an interprocess communication control device according to a second embodiment of the present invention;

FIG. 12 is a block diagram showing a hardware configuration of the interprocess communication control device according to the second embodiment of the present invention;

FIG. 13 is a schematic diagram showing relationships among threads of the interprocess communication control device according to the second embodiment of the present invention;

FIG. 14 is a flowchart showing a sequence of processing performed by a CPU substrate of the interprocess communication control device according to the second embodiment of the present invention;

FIG. 15 is a schematic diagram showing a data structure of communication data transmitted by an interprocess communication system according to the second embodiment of the present invention; and

FIG. 16 is a flowchart showing a sequence of processing performed by the CPU substrate of the interprocess communication control device in the case where the processing includes determining processing concerning information for identifying a destination thread.

### DETAILED DESCRIPTION OF THE PREFERRED EMBODIMENTS

An interprocess communication system (device) according to the preferred embodiments of the present invention will be described in detail hereinafter with reference to the drawings. In the embodiments described below, a term “process” means an instance or the like being executed by a program, and this term represents a broad concept which indicates an execution entity to which a plurality of threads belong. A “thread” is a unit of CPU usage and is a unit of program execution. In program execution, context information for a thread is smaller than that for a process, and processing is switched faster between threads than between processes. One application comprises one or more processes, and one or more threads belong to one process. Here, “information for identifying a thread” is a broad concept which is not limited to particular information but may be any information such as a thread number, thread ID or the like which allows a thread to be identified. Also, “destination” herein means a side to which communication data is transmitted, i.e., a receiving end.

### First Embodiment

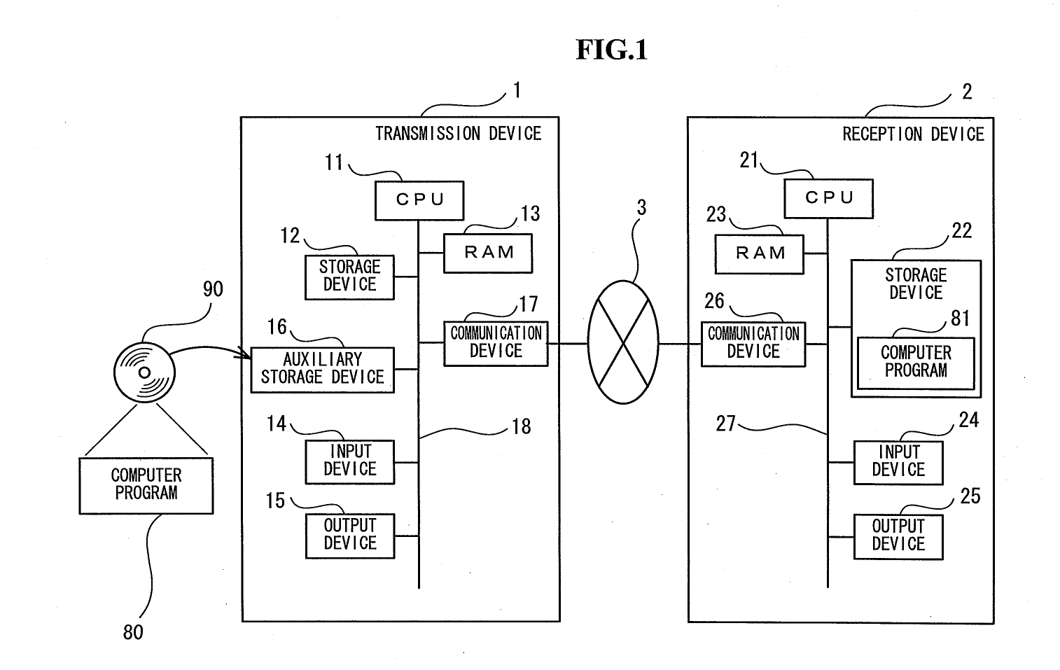

FIG. 1 is a block diagram showing a configuration of an interprocess communication system according to a first embodiment of the present invention. As shown in FIG. 1, the interprocess communication system according to the first embodiment comprises a transmission device 1 and a reception device 2 which are connected to each other such that communication data can be transmitted/received therebetween via a network 3. Here, the term “network 3” is used as a broad concept which is not limited to a particular type of communication but may include, e.g., from remote communication via the Internet, WAN or the like to serial communication via a simple cable connection.

The transmission device 1 comprises at least a CPU (Central Processing Unit) 11, a storage device 12, a RAM 13, an input device 14, an output device 15, an auxiliary storage device 16, a communication device 17 and an internal bus 18 for connecting these hardware components. The CPU 11 is connected to the above hardware components of the transmission device 1 via the internal bus 18. The CPU 11 controls operations of the above hardware components, and executes various software-like functions in accordance with a computer program 80 stored in the storage device 12. The RAM 13 is structured with an SRAM, flash memory or the like. A load module is loaded into the RAM 13 at the time of executing the computer program 80, and the RAM 13 stores temporary data or the like which is generated when the computer program 80 is executed.

The storage device 12 is structured with a built-in fixed-type storage device (hard disc), ROM or the like. The computer program 80 stored in the storage device 12 is downloaded by the auxiliary storage device 16 from a portable recording medium 90 such as a DVD, CD-ROM or the like in which information such as a program, data and the like are recorded, and at the time of executing the computer program 80, the computer program 80 is loaded to the RAM 13 from the storage device 12, and then executed. Of course, the computer program 80 may be downloaded from an external computer via the communication device 17.

The communication device 17 is connected to the internal bus 18, and capable of performing data transmission/reception with an external computer or the like by connecting to the network 3 which is an external network such as the Internet, LAN, WAN or the like. In other words, the storage device 12 is not limited to the one to be built in the transmission device 1, but may be an external storage medium such as a hard disk or the like provided in, for example, an external server computer which is connected to the transmission device 1 via the communication device 17.

The input device 14 is a data input medium such as a keyboard, mouse or the like. The output device 15 is, for example, a display device such as a CRT monitor, LCD or the like, or a printing device such as a laser printer, dot matrix printer or the like.

Similarly to the transmission device 1, the reception device 2 also comprises at least a CPU (Central Processing Unit) 21, a storage device 22, a RAM 23, an input device 24, an output device 25, a communication device 26, and an internal bus 27 for connecting these hardware components. The CPU 21 is connected to the above hardware components of the reception device 2 via the internal bus 27. The CPU 21 controls operations of the above hardware components, and executes various software-like functions in accordance with a computer program 81 stored in the storage device 22. The RAM 23 is structured with an SRAM, flash memory or the like. A load module is loaded into the RAM 23 at the time of executing the computer program 81, and the RAM 23 stores temporary data or the like which is generated when the computer program 81 is executed.

The storage device 22 is structured with a built-in fixed-type storage device (hard disk), ROM or the like. The computer program 81 stored in the storage device 22 is information such as a program, data and the like downloaded from, for example, an external computer via the communication device 26. At the time of executing the computer program 81, the computer program 81 is loaded from the storage device 22 to the RAM 23, and then executed.

The communication device 26 is connected to the internal bus 27, and capable of performing data transmission/reception with an external computer or the like by connecting to the network 3 which is an external network such as the Internet, LAN, WAN or the like.

Used as the input device 24 is not only a data input medium such as a keyboard, mouse or the like but may also include, in the case where the reception device 2 is, for example, an inspection device, analyzer or the like for inspecting or analyzing a subject, overall information obtaining means for obtaining information from the subject. The output device 25 is, for example, a display device such as a CRT monitor, LCD or the like, or a printing device such as a laser printer, dot matrix printer or the like.

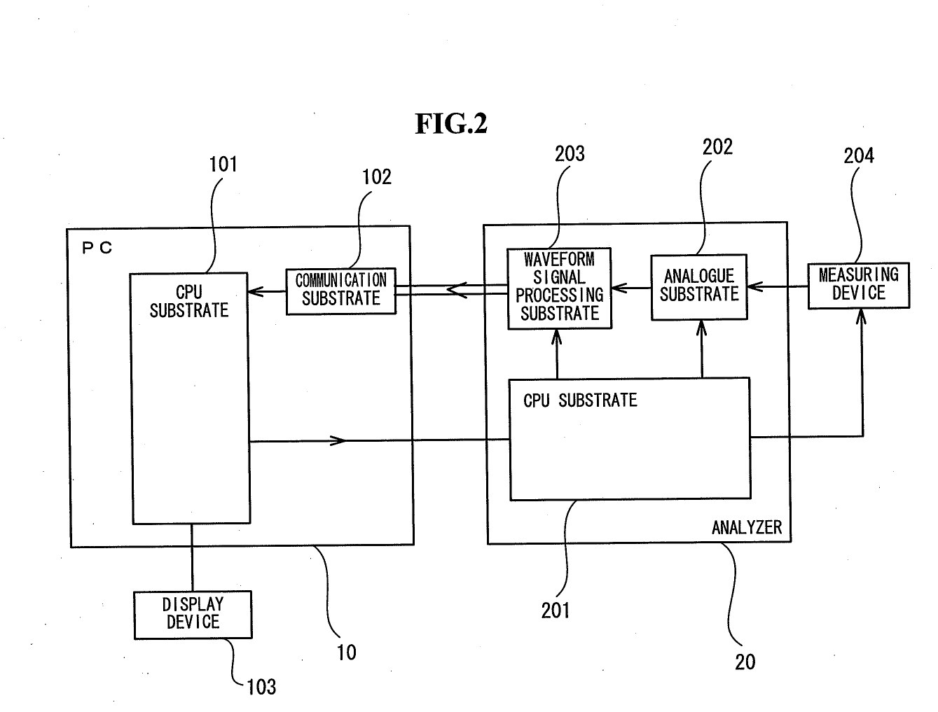

Described below as a specific exemplary application of the present invention is a case where a personal computer (hereinafter, referred to as a PC) is used as the transmission device 1, and an analyzer, for measuring and analyzing density, particle sizes, particle size distribution and the like of material particles suspended in aqueous solution, is used as the reception device 2. FIG. 2 is a block diagram showing a hardware configuration of the interprocess communication system according to the first embodiment of the present invention.

As shown in FIG. 2, in the interprocess communication system according to the first embodiment, settings information for an analyzer 20, which settings information is set in a PC 10, is transmitted to the analyzer 20 by interprocess communication. Here, the interprocess communication is not limited to a particular type of communication but may be named pipe communication, socket communication, or the like. In the first embodiment, TCP/IP socket communication is used.

The CPU substrate 101 transmits settings information and the like used for measurement control by the analyzer 20, to the analyzer 20 via a LAN cable or the like which is connected to the analyzer 20 by the TCP/IP protocol. Transmission of the settings information or the like is performed by interprocess communication. Here, the interprocess communication is socket communication.

A CPU substrate 201 of the analyzer 20 performs operation control of a measuring device 204, and also performs control so as to preprocess, at an analogue substrate 202, analogue data measured by the measuring device 204 and to digitize the preprocessed data at a waveform signal processing substrate 203. In accordance with an instruction from the CPU substrate 201, the measuring device 204 inputs a measurement result to the analogue substrate 202. The settings information received from the PC 10 by socket communication is used as configuration parameters by the analogue substrate 202 and the waveform signal processing substrate 203 of the analyzer 20.

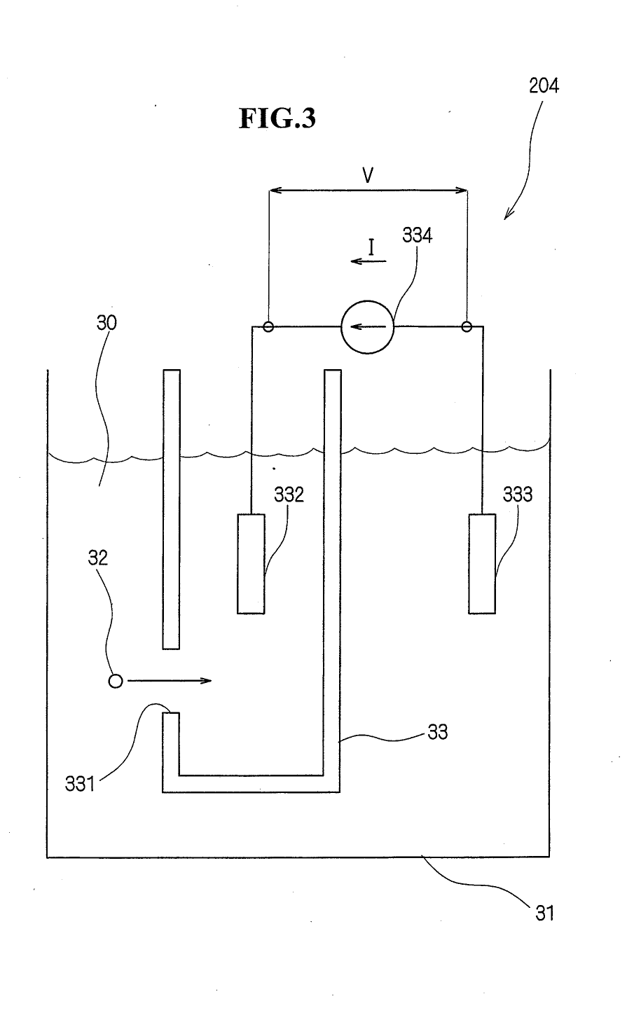

FIG. 3 is a schematic diagram showing a brief structure of the measuring device 204 of the analyzer 20 according to the first embodiment. A beaker 31 is filled with aqueous solution 30 in which fine particles 32 are suspended, and a detector 33 is inserted in the aqueous solution 30. The detector 33 is, near an edge portion thereof, provided with a pore 331 through which the fine particles 32 can pass, and a direct current source 334 is used to cause a constant direct current I to flow between an internal electrode 332 and an external electrode 333 which are respectively provided inside and outside of the detector 33.

By applying a negative pressure inside the detector 33 by using a pump or the like (not shown), the aqueous solution 30 is drawn into the detector 33 through the pore 331, whereby the fine particles 32 suspended in the aqueous solution 30 pass through the pore 331. Pump control, valve control and the like for controlling the negative pressure are also performed by the CPU substrate 201. When a fine particle 32 passes through the pore 331, electrical resistance at the pore 331 varies in accordance with a size of the fine particle 32, and therefore, electrical resistance between the internal electrode 332 and the external electrode 333 also varies. Since the constant direct current I flows between the internal electrode 332 and the external electrode 333, the sizes, number and the like of the fine particles 32 having passed through the pore 331 can be detected, based on Ohm's law, by measuring a voltage V between the internal electrode 332 and the external electrode 333.

The measured voltage V is inputted to the analogue substrate 202 as an analogue signal. The inputted voltage V which indicates a very small voltage variation therein is amplified by an amplifier or the like at the analogue substrate 202. A gain value for adjusting a degree of the amplification, an offset value for shifting the entire voltage signal, and the like, which are pieces of settings information for performing preprocessing on the analogue signal, are inputted to the PC 10, and transmitted to the analyzer 20 by interprocess communication. Upon receiving the settings information, the CPU substrate 201 of the analyzer 20 transmits the settings information to the analogue substrate 202, and performs preprocessing on the analogue signal prior to converting the analogue signal to a digital signal.

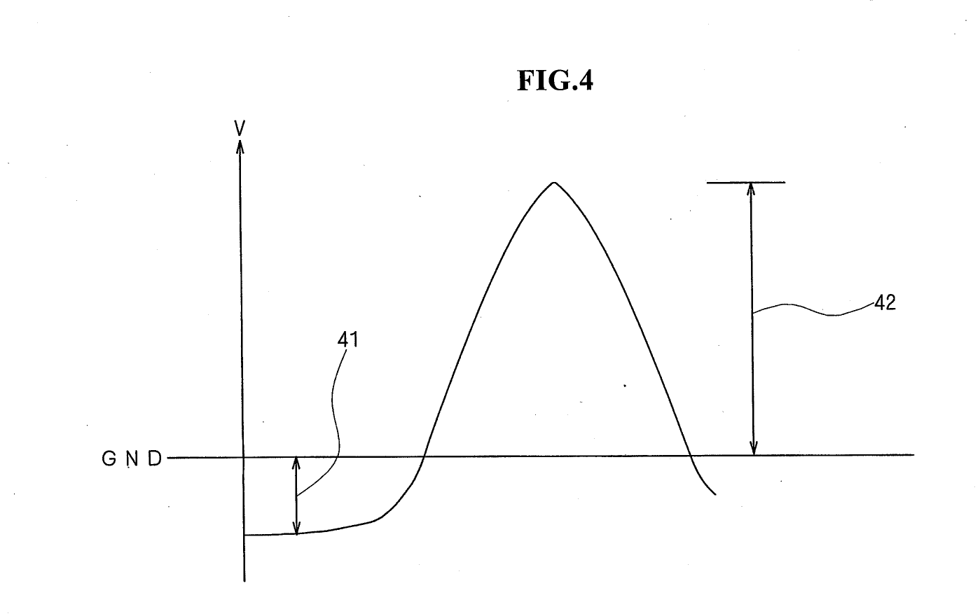

FIG. 4 is a schematic diagram for describing the settings information obtained by the analogue substrate 202. For the inputted analogue signal for which a ground voltage GND is set as an origin, a gain value 42 indicates a settings value of a multiplication factor for amplifying a value of the analogue signal. Further, the offset value 41 indicates a settings value for shifting the entire analogue signal to remove a drift and the like of the signal.

The preprocessed analogue signal is sent to the waveform signal processing substrate 203, and then converted into a digital signal. In the waveform signal processing substrate 203, only a signal having a value greater than a particular level value (greater than a noise cut level value) is to be converted to a digital signal. A signal whose pulse width is greater than a predetermined pulse width is determined to be noise, and not converted to a digital signal. Accordingly, inputted to the PC 10 as the settings information for signal digitization are: the noise cut level value used for determining, based on a magnitude of a signal, whether or not to convert the signal to a digital signal; a maximum pulse width which defines a maximum value of a pulse width of a signal to be converted to a digital signal; and the like, and these pieces of settings information are transmitted to the analyzer 20 by interprocess communication. Upon receiving the settings information, the CPU substrate 201 of the analyzer 20 transmits the settings information to the waveform signal processing substrate 203, and then signal digitization is performed.

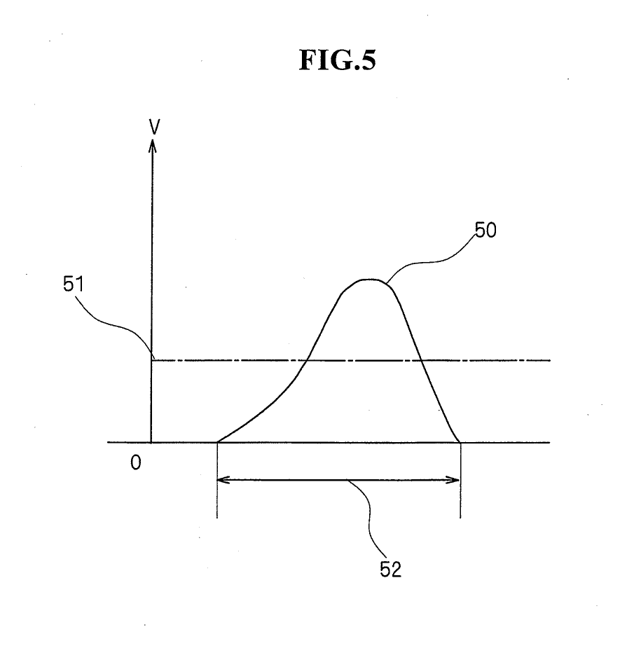

FIG. 5 is a schematic diagram for describing the settings information obtained by the waveform signal processing substrate 203. For an analogue signal 50 whose waveform has been adjusted by the analogue substrate 202, a noise cut level value 51 indicates a reference level which is used such that when a maximum value of the analogue signal 50 exceeds the noise cut level value 51, it is determined that a fine particle 32 has been detected and the analogue signal 50 is to be converted to a digital signal. Also, a maximum pulse width 52 indicates a determination reference which is used such that when a pulse width of the analogue signal 50 exceeds the maximum pulse width 52, the analogue signal 50 is determined to be noise and then the analogue signal 50 is not converted to a digital signal.

In the first embodiment, a maximum pulse number is used as the maximum pulse width 52. The maximum pulse number is a maximum value of the number of minimal amplitude pulses which are obtained when the analogue signal 50 is digitized. If this maximum value is exceeded, this means that a presence of a fine particle 32, whose diameter is greater than that which can pass through the pore 331 for drawing in the fine particle 32, has been falsely detected. Accordingly, in this case, the analogue signal 50 is determined to be noise.

Processing performed at the waveform signal processing substrate 203 is not limited to the above. For example, prior to the signal digitization, a filtering process, which uses a low-pass filter, band-pass filter or the like for removing high-frequency components, may be performed. In this case, selection information for selecting, for example, a band-pass filter that performs the filtering process is inputted to the PC 10 as a piece of settings information, and transmitted to the analyzer 20 by interprocess communication. Upon receiving the selection information, the CPU substrate 201 of the analyzer 20 transmits the selection information to the waveform signal processing substrate 203, and then the band-pass filter for performing the filtering process is selected in accordance with the selection information.

The waveform signal processing substrate 203 transmits, to the PC 10, waveform information having been converted to a digital signal, as information about the fine particle 32. Transmission of the information about the fine particle 32 is performed via, for example, a USB cable connected by USB. Of course, the transmission is not limited to a transmission via a USB cable.

After receiving information about fine particles 32 via a communication substrate 102, the PC 10 analyzes, at the CPU substrate 101, the information about the fine particles 32. Then, the CPU substrate 101 calculates the number, particle sizes, particle size distribution and the like, of the fine particles 32 contained in the aqueous solution 30, and then outputs a result thereof to a display device 103 for display.

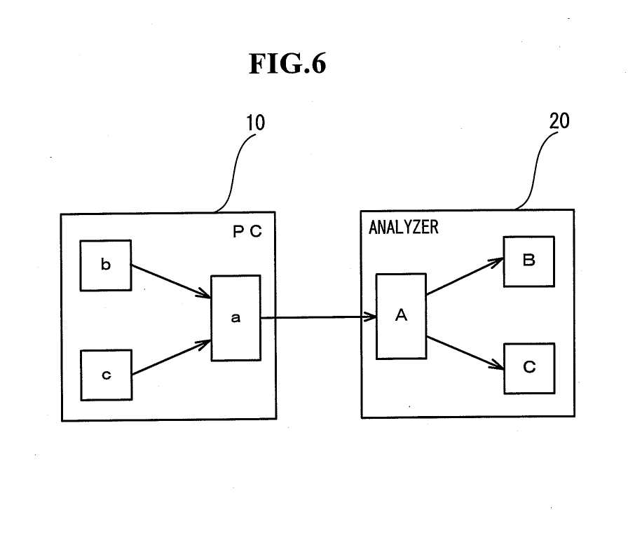

Hereinafter, a processing flow of the interprocess communication system having the above configuration will be described. FIG. 6 is a schematic diagram showing relationships among threads of the interprocess communication system according to the first embodiment of the present invention. The PC 10 generates and executes a process comprising: a thread b for obtaining the settings information for the analogue substrate 202; a thread c for obtaining the settings information for the waveform signal processing substrate 203; and a thread a for transmitting these pieces of settings information to the analyzer 20 by interprocess communication. Meanwhile, the analyzer 20 generates and executes a process comprising: a thread A for receiving these pieces of settings information from the PC 10 by interprocess communication; a thread B for setting the received settings information for the analogue substrate 202; and a thread C for setting the received settings information for the waveform signal processing substrate 203.

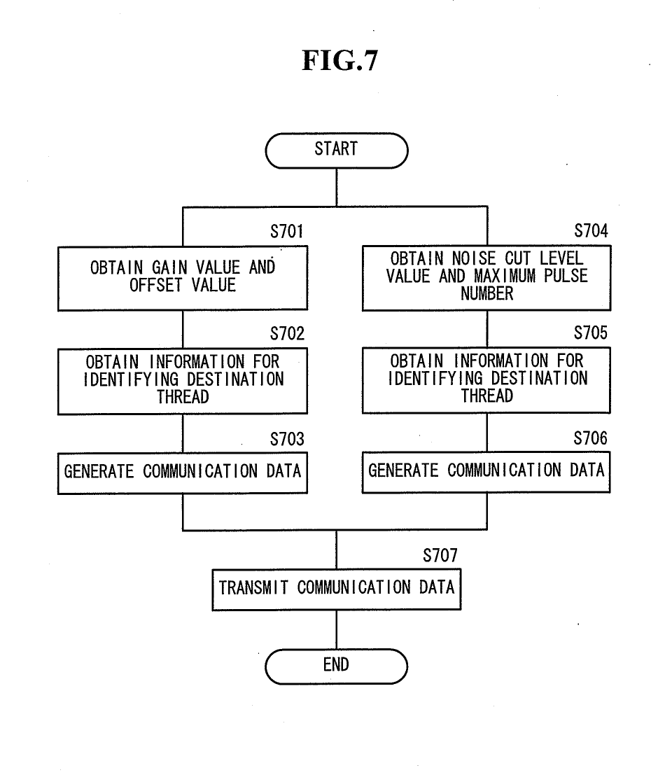

FIG. 7 is a flowchart showing a sequence of processing performed by the CPU substrate 101 of the PC 10 (transmission device) of the interprocess communication system according to the first embodiment of the present invention. The CPU substrate 101 of the PC 10 obtains the gain value and the offset value as the settings information for the analogue substrate 202 of the analyzer 20 (reception device) (step S701: thread b). To be specific, the gain value and the offset value are read by referring to device information stored in the storage device 12 or in the RAM 13 in the CPU substrate 101. Of course, the gain value and the offset value may be directly inputted from the input device 14.

The CPU substrate 101 obtains information for identifying a thread on the CPU substrate 201 of the analyzer 20 (reception device), i.e., obtains information for identifying a destination thread (step S702: thread b), and generates communication data containing the information for identifying the destination thread (step S703: thread b). The information for identifying the destination thread is, similarly to the obtained settings information for the analogue substrate 202, stored in the storage device 12 or in the RAM 13 in the CPU substrate 101. Of course, the information for identifying the destination thread may be set as a fixed program code.

Next, the CPU substrate 101 obtains, as the settings information for the waveform signal processing substrate 203 of the analyzer 20, the noise cut level value and the maximum pulse number (step S704: thread c). To be specific, the noise cut level value and the maximum pulse number are read by referring to the device information stored in the storage device 12 or in the RAM 13 in the CPU substrate 101. Of course, the noise cut level value and the maximum pulse number may be directly inputted from the input device 14.

The CPU substrate 101 obtains information for identifying a thread on the CPU substrate 201 of the analyzer 20 (reception device), i.e., obtains information for identifying a destination thread (step S705: thread c), and generates communication data containing the information for identifying the destination thread (step S706: thread c). The information for identifying the destination thread is, similarly to the obtained settings information for the waveform signal processing substrate 203, stored in the storage device 12 or in the RAM 13 in the CPU substrate 101. Of course, the information for identifying the destination thread may be set as a fixed program code.

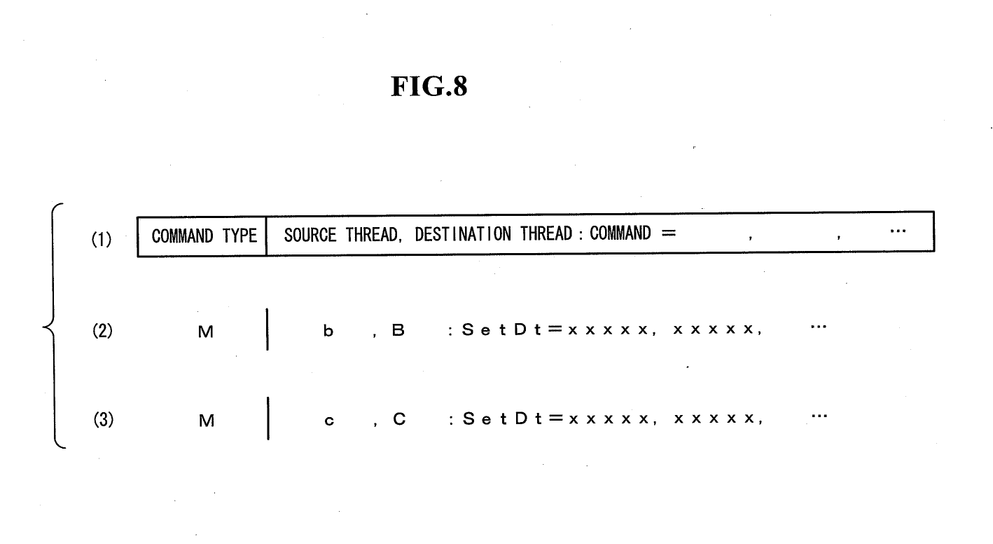

The CPU substrate 101 transmits these pieces of generated communication data (each containing the information for identifying a destination thread) to a specified process by interprocess communication (step S707: thread a). These pieces of communication data, which are respectively generated by the threads b and c for the purpose of transmitting the settings information to the analyzer 20 by interprocess communication, each have a data structure specific to the present invention. FIG. 8 is a schematic diagram showing a data structure of communication data transmitted by the interprocess communication system according to the first embodiment of the present invention.

As shown in FIG. 8(1), a header portion of the data structure according to the first embodiment specifies a command type which specifies a type of processing to be performed based on the transmitted communication data. An item next to the header portion specifies information for identifying a source thread and information for identifying a destination thread. It is understood that in the case where the processing based on the communication data is not complex, the information for identifying a source thread can be omitted.

Further, the information for identifying a source thread and the information for identifying a destination thread are not limited to a particular type of information but may be any information such as a thread number, thread identifier or the like. However, a thread number is preferred so as to reduce processing load for a receiving thread. In the case where these threads are each identified by a thread number, the communication data is simply transferred to a thread indicated by a specified thread number. Therefore, there is no necessity to separately perform processing for specifying the thread which is a destination of the communication data. Of course, it is understood that in the case where the threads are each identified by other information than a thread number, the communication data can be easily transferred by preparing, for example, a conversion table for converting the other information to a thread number and thereby converting the information for identifying a destination thread to a thread number.

The next item specifies processing to be performed by the destination thread, and specifies necessary information for the processing. (2) and (3) of FIG. 8 show exemplary data structures of the pieces of communication data generated by the thread b and the thread c, respectively. The examples of (2) and (3) of FIG. 8 show data structures for transmitting, as transmission information, the settings information set for the analogue substrate 202 and the settings information set for the waveform signal processing substrate 203. To be specific, “SetDt” is used as a settings command for these pieces of settings information. Necessary settings information can be freely added by using “,” which is data separation information (hereinafter, referred to as a separator). Thus, each piece of communication data is variable-length data. Note that the separator is not limited to “,” but may be anything which is distinguishable from transmission information.

In the case of changing details of processing performed in a thread for preparing communication data to be transmitted/received, using variable-length data as the communication data eliminates a necessity to update a program corresponding to a thread for transmitting/receiving the communication data between processes, although there is still a necessity to update a program corresponding to the thread for which the details of processing are changed. For example, in the case where processing by programs corresponding to the thread b and the thread B is changed, only the programs corresponding to the thread b and the thread B are updated, and there is no necessity to update programs corresponding to the thread a and the thread A. Accordingly, the number of programs to be updated in accordance with a change in processing details is minimized, and thus a probability of a program bug occurring due to updating can be reduced.

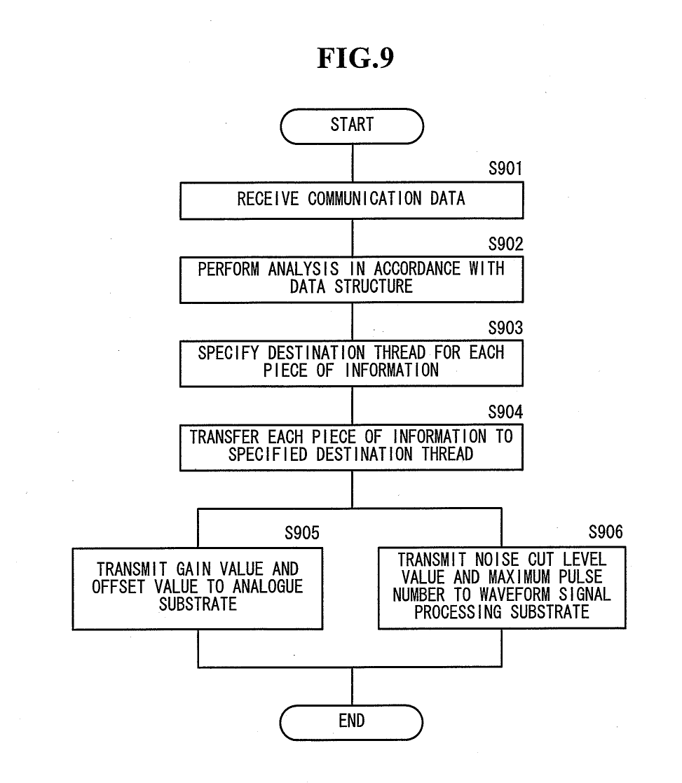

FIG. 9 is a flowchart showing a sequence of processing performed by the CPU substrate 201 of the analyzer 20 (reception device) of the interprocess communication system according to the first embodiment of the present invention. The CPU substrate 201 of the analyzer 20 receives, by interprocess communication, pieces of communication data that contain, as settings information, the gain value, the offset value, the noise cut level value and the maximum pulse number (step S901: thread A). The pieces of communication data to be received here are the pieces of communication data generated by the thread b and the thread c, respectively.

The CPU substrate 201 analyzes the pieces of received communication data in accordance with, for example, the data structures as shown in FIG. 8 (step S902: thread A). To be specific, first, data is read to “|”, and the data is recognized as information for specifying a command type that specifies a type of processing. Next, data is read from “|” to “:”, and the data is recognized as information for identifying a source thread and information for identifying a destination thread. If “,” is detected between “|” to “:”, the data from “|” to “,” is recognized as the information for identifying a source thread, and the data subsequent to “,” is recognized as the information for identifying a destination thread. If “,” is not detected, it is recognized that only the information for identifying a destination thread is present.

Next, data subsequent to “:” is read, and it is determined whether or not processing to be performed (i.e., command, property, event, etc) is stored in the CPU substrate 201 in advance. When it is determined that processing to be performed is stored in the CPU substrate 201 in advance, the separator “,” is searched, and each time the separator “,” is detected, data up to the detected separator “,” is recognized as information relating to corresponding processing.

In the example of FIG. 8(2), “SetDt” is recognized as a command; data from “=” to the separator “,” is recognized as the gain value; and data from the separator to the next separator “,” is recognized as the offset value.

Similarly, in the example of FIG. 8(3), “SetDt” is recognized as a command; data from“=” to the separator is recognized as the noise cut level value; and data from the separator to the next separator “,” is recognized as the maximum pulse number.

In the case of further adding data, for example, in the case of specifying a type of a band-pass filter to be selected by the thread c at the waveform signal processing substrate 203, the separator “,” may be further added so as to add data which indicates the type of a band-pass filter. In this case, the CPU substrate 201 simply recognizes the data up to the next separator “,” as a band-pass filter type, and thus there is no necessity to change the data structure of the communication data.

The CPU substrate 201 specifies destination threads, based on the information for identifying a destination thread, which information is contained in each piece of communication data (step S903: thread A), and transfers, to the specified threads, the gain value, the offset value, the noise cut level value and the maximum pulse number which are pieces of settings information (step S904: thread A). The CPU substrate 201 transmits the gain value and the offset value to the analogue substrate 202 as settings information (step S905: thread B), and transmits the noise cut level value and the maximum pulse number to the waveform signal processing substrate 203 as settings information (step S906: thread C). The analogue substrate 202 and the waveform signal processing substrate 203 each set the received settings information as configuration parameters.

As described above, according to the first embodiment, by containing, in the communication data, information for identifying a destination thread, a program which creates a thread for performing interprocess communication can be generalized. Accordingly, even if there occurs a change in contents of data to be transmitted/received as the communication data and program updating is caused, it is not necessary to update a program corresponding to a thread for interprocess communication. This makes it possible to reduce overall man-hours for program updating and reduce occurrences of bugs due to corrections in the program updating.

Further, by having a data structure as shown in FIG. 8, there is no necessity to update, in the case where, for example, there is an item to be added to or to be deleted from contents of data to be transmitted/received as the communication data, a program corresponding to a thread for interprocess communication. This makes it possible to reduce overall man-hours for program updating and reduce occurrences of bugs due to corrections in the program updating.

Still further, processing capability of the CPU substrate 201 of the above-described analyzer 20 or the like is generally lower than that of the CPU substrate 101 of the PC 10. Therefore, by using a thread number as information for identifying a destination thread, arithmetic processing load on the CPU substrate 201 can be reduced, and also, a secondary effect can be expected, in which a throughput for obtaining an analysis result is reduced.

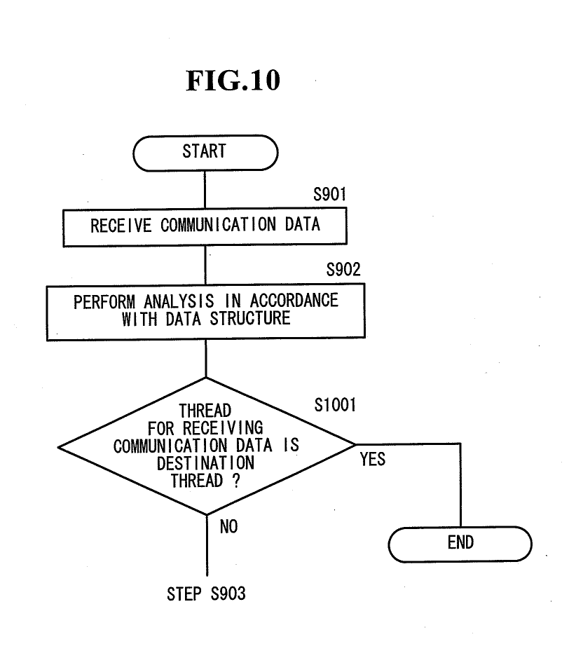

Still further, when the CPU substrate 201 receives the settings information (contained in the communication data) for setting communication specifications of interprocess communication, it is not necessary to transfer the received communication data. Here, the CPU substrate 201 may determine whether or not information for identifying a destination thread of the received communication data indicates a thread for directly receiving the communication data (thread A in the above example). FIG. 10 is a flowchart showing a sequence of processing performed by the CPU substrate 201 of the analyzer 20 (reception device) in the case where the processing includes determination processing for the information for identifying a destination thread.

By interprocess communication, the CPU substrate 201 of the analyzer 20 receives communication data which contains, as settings information, the gain value, the offset value, the noise cut level value and the maximum pulse number (step S901: thread A), and analyzes the communication data in the same manner as that of the above-described embodiment (step S902: thread A). Then, the CPU substrate 201 determines whether or not the information for identifying a destination thread indicates the thread A which is a thread for receiving the communication data (step S1001).

In the case where the CPU substrate 201 determines that the thread A for receiving the communication data is indicated (step S1001: YES), the CPU substrate 201 determines that the processing is to be completed in the thread A, and the processing ends without transferring the communication data. When the CPU substrate 201 determines that the thread A for receiving the communication data is not indicated (step S1001: NO), the processing proceeds to step S903 and the above-described processing is performed.

As described above, by adding the processing for determining whether or not the information, for identifying a destination thread of the received communication data, indicates a thread for directly receiving the communication data (thread A in the above example), it can be determined whether or not the communication data is directed to the thread for directly receiving the communication data. In this manner, the necessity or unnecessariness for transfer of the received communication data can be determined.

### Second Embodiment

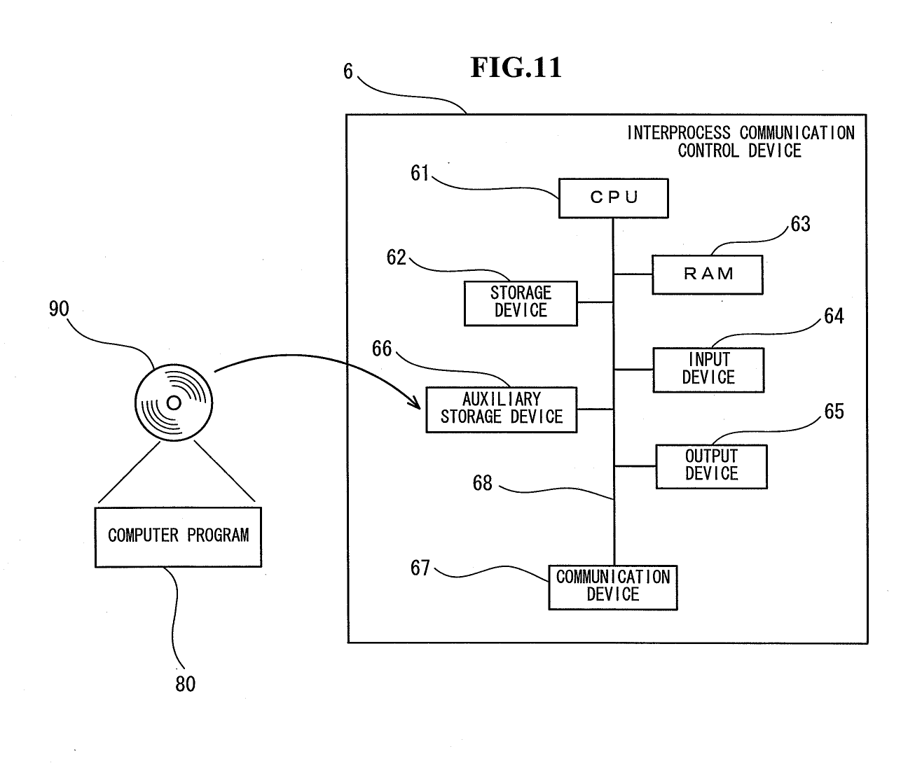

FIG. 11 is a block diagram showing a configuration of an interprocess communication control device 6 according to a second embodiment of the present invention. As shown in FIG. 11, the interprocess communication control device 6 according to the second embodiment comprises at least a CPU (Central Processing Unit) 61, a storage device 62, a RAM 63, an input device 64, an output device 65, an auxiliary storage device 66, a communication device 67 and an internal bus 68 for connecting these hardware components. The CPU 16 is connected to the above hardware components of the interprocess communication control device 6 via the internal bus 68. The CPU 11 controls operations of the above hardware components, and executes various software-like functions in accordance with the computer program 80 stored in the storage device 62. The RAM 63 is structured with an SRAM, flash memory or the like. A load module is loaded into the RAM 63 at the time of executing the computer program 80, and the RAM 63 stores temporary data or the like which is generated when the computer program 80 is executed.

The storage device 62 is structured with a built-in fixed-type storage device (hard disc), ROM or the like. The computer program 80 stored in the storage device 62 is downloaded by the auxiliary storage device 66 from the portable recording medium 90 such as a DVD, CD-ROM or the like in which information such as a program, data and the like are recorded, and at the time of executing the computer program 80, the computer program 80 is loaded to the RAM 63 from the storage device 62, and then executed. Of course, the computer program 80 may be downloaded from an external computer via the communication device 67.

The communication device 67 is connected to the internal bus 68, and capable of performing data transmission/reception with an external computer or the like by connecting to an external network such as the Internet, LAN, WAN or the like. In other words, the storage device 62 is not limited to the one to be built in the interprocess communication control device 6, but may be an external storage medium such as a hard disk or the like provided in, for example, an external server computer which is connected to the interprocess communication device 6 via the communication device 67.

Used as the input device 64 is not only a data input medium such as a keyboard, mouse or the like but may also include, in the case where the interprocess communication control device 6 is integrated with, for example, an inspection device, analyzer or the like for performing particular processing, overall information obtaining means for obtaining information from a subject of an inspection, analysis or the like. The output device 65 is, for example, a display device such as a CRT monitor, LCD or the like, or a printing device such as a laser printer, dot matrix printer or the like.

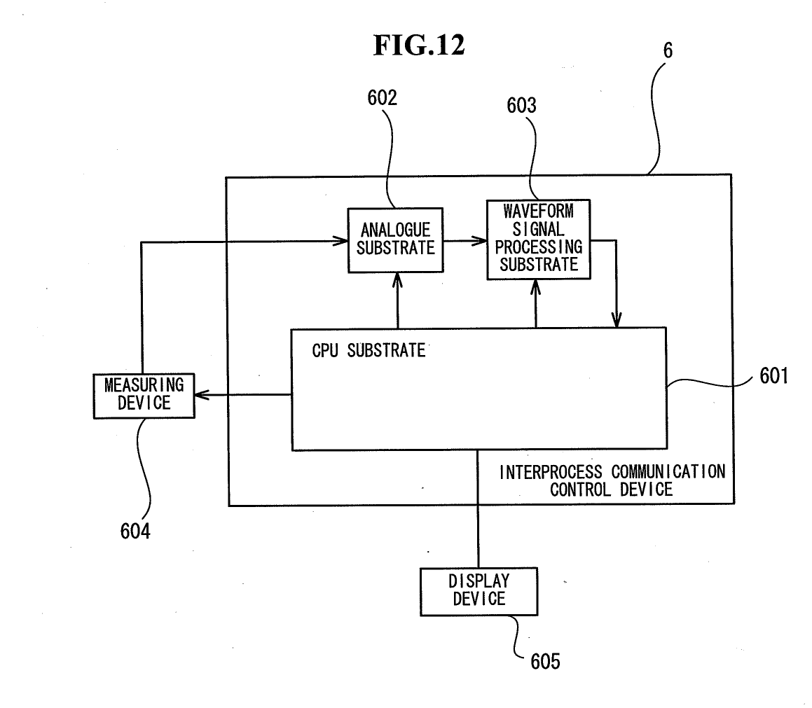

Described below as a specific exemplary application of the present invention is a case where the interprocess communication control device 6 is integrated with an analyzer for measuring and analyzing density, particle sizes, particle size distribution and the like of material particles suspended in aqueous solution. FIG. 12 is a block diagram showing a hardware configuration of the interprocess communication control device 6 according to the second embodiment of the present invention.

As shown in FIG. 12, the interprocess communication control device 6 according to the second embodiment performs interprocess communication in the CPU substrate 601, thereby transmitting necessary settings information to a thread which directly performs processing. Here, the interprocess communication is not limited to a particular type of communication but may be named pipe communication, socket communication, or the like. Similarly to the first embodiment, TCP/IP socket communication is used in the second embodiment.

In accordance with an instruction from the CPU substrate 601, a measuring device 604 inputs a measurement result to an analogue substrate 602. Settings information received by the socket communication is used as configuration parameters by the analogue substrate 602 and a waveform signal processing substrate 603.

Since a configuration of analyzer components and settings information for the analogue substrate and the waveform signal processing substrate are the same as those of the first embodiment, these are denoted by the same reference numerals as those used in the first embodiment, and detailed descriptions thereof will be omitted.

The waveform signal processing substrate 603 returns, to the CPU substrate 601, waveform information having been converted to digital signals, as information about the fine particles 32. The CPU substrate 601 analyzes the received information about the fine particles 32, and calculates the number, particle sizes, particle size distribution and the like of the fine particles 32 contained in the aqueous solution 30, and then outputs a result thereof to a display device 605 for display.

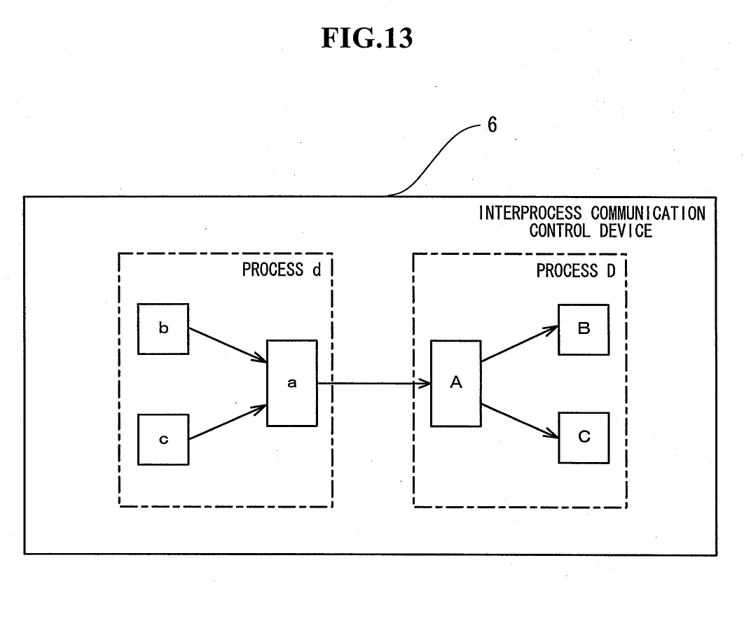

Hereinafter, a processing flow of the CPU substrate 601 of the interprocess communication control device 6 having the above configuration will be described. FIG. 13 is a schematic diagram showing relationships among threads of the interprocess communication control device 6 according to the second embodiment of the present invention. The interprocess communication control device 6 generates and executes a process d comprising: a thread b for obtaining settings information for the analogue substrate 602; a thread c for obtaining settings information for the waveform signal processing substrate 603; and a thread a for transmitting these pieces of settings information to another process by interprocess communication, and generates and executes a process D comprising: a thread A for receiving these pieces of settings information by interprocess communication; a thread B for setting the received settings information for the analogue substrate 602; and a thread C for setting the received settings information for the waveform signal processing substrate 603.

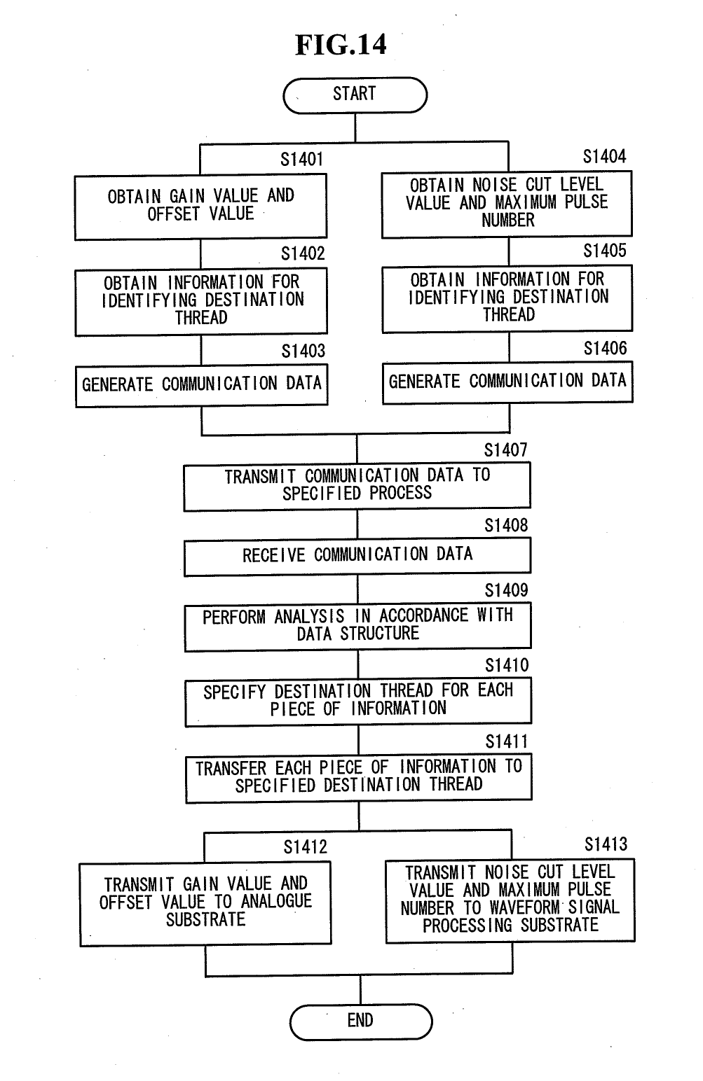

FIG. 14 is a flowchart showing a sequence of processing performed by the CPU substrate 601 of the interprocess communication control device 6 according to the second embodiment of the present invention. The CPU substrate 601 of the interprocess communication control device 6 obtains the gain value and the offset value as the settings information for the analogue substrate 602 (step S1401: thread b). To be specific, the gain value and the offset value are read by referring to device information stored in the storage device 62 or in the RAM 63 in the CPU substrate 601. Of course, the gain value and the offset value may be directly inputted from the input device 64.

The CPU substrate 601 obtains information for identifying a destination thread (step S1402: thread b), and generates communication data containing the information for identifying the destination thread (step S1403: thread b). The information for identifying the destination thread is, similarly to the obtained settings information for the analogue substrate 602, stored in the storage device 62 or in the RAM 63 in the CPU substrate 601. Of course, the information for identifying the destination thread may be set as a fixed program code.

Next, the CPU substrate 601 obtains, as the settings information for the waveform signal processing substrate 603, the noise cut level value and the maximum pulse number (step S1404: thread c). To be specific, the noise cut level value and the maximum pulse number are read by referring to device information stored in the storage device 62 or in the RAM 63 in the CPU substrate 601. Of course, the noise cut level value and the maximum pulse number may be directly inputted from the input device 64.

The CPU substrate 601 obtains information for identifying a destination thread (step S1405: thread c), and generates communication data containing the information for identifying the destination thread (step S1406: thread c). The information for identifying the destination thread is, similarly to the obtained settings information for the waveform signal processing substrate 603, stored in the storage device 62 or in the RAM 63 in the CPU substrate 601. Of course, the information for identifying the destination thread may be set as a fixed program code.

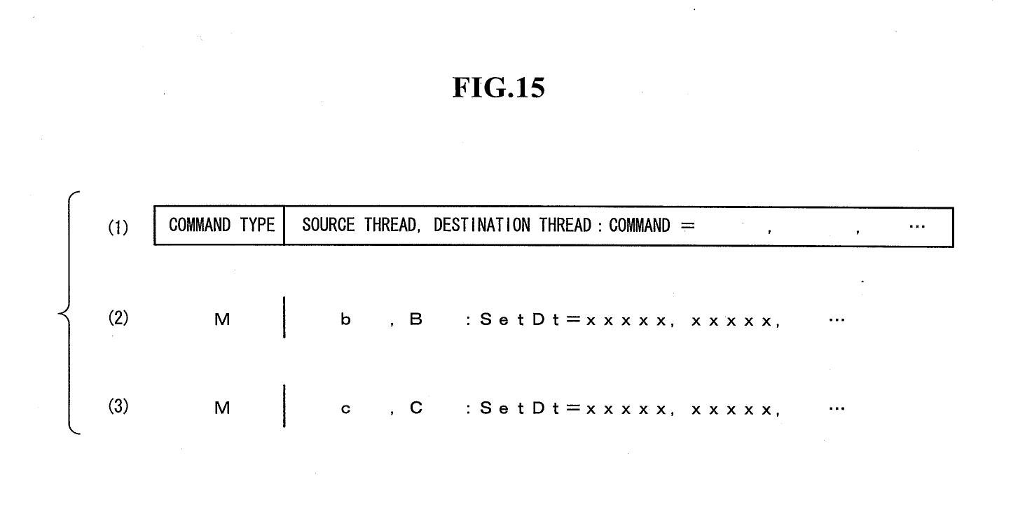

The CPU substrate 601 transmits these pieces of generated communication data (each containing the information for identifying a destination thread) to a specified process (process D) by interprocess communication (step S1407: thread a). These pieces of communication data, which are respectively generated by the thread b and the thread c for the purpose of transmitting the settings information to the process D by interprocess communication, each have a data structure specific to the present invention. FIG. 15 is a schematic diagram showing a data structure of communication data transmitted by the interprocess communication control device 6 according to the second embodiment of the present invention.

As shown in FIG. 15(1), a header portion of the data structure according to the second embodiment specifies a command type which specifies a type of processing to be performed based on the transmitted communication data. An item next to the header portion specifies information for identifying a source thread and information for identifying a destination thread. It is understood that in the case where the processing based on the communication data is not complex, the information for identifying a source thread can be omitted.

Further, the information for identifying a source thread and the information for identifying a destination thread are not limited to a particular type of information but may be any information such as a thread number, thread identifier or the like. However, a thread number is preferred so as to reduce processing load for a receiving thread. In the case where these threads are each identified by a thread number, the communication data is simply transferred to a thread indicated by a specified thread number. Therefore, there is no necessity to separately perform processing for specifying the thread which is a destination of the communication data. Of course, it is understood that in the case where the threads are each identified by other information than a thread number, the communication data can be easily transferred by preparing, for example, a conversion table for converting the other information to a thread number and thereby converting the information for identifying a destination thread to a thread number.

The next item specifies processing to be performed by the destination thread, and specifies necessary information for the processing. (2) and (3) of FIG. 15 show exemplary data structures of the pieces of communication data generated by the thread b and the thread c, respectively. The examples of (2) and (3) of FIG. 15 show data structures for transmitting, as transmission information, the settings information set for the analogue substrate 602 and the settings information set for the waveform signal processing substrate 603. To be specific, “SetDt” is used as a settings command for these pieces of settings information. Necessary settings information can be freely added by using “,” which is data separation information (hereinafter, referred to as a separator). Thus, each piece of communication data is variable-length data. Note that the separator is not limited to “,” but may be anything which is distinguishable from transmission information.

In the case of changing details of processing performed in a thread for preparing communication data to be transmitted/received, using variable-length data as the communication data eliminates a necessity to update a program corresponding to an interprocess communication thread for transmitting/receiving the communication data between processes, although there is still a necessity to update a program corresponding to the thread for which the details of processing are changed. For example, in the case where details of processing by programs corresponding to the thread b and the thread B are changed, only the programs corresponding to the thread b and the thread B are updated, and there is no necessity to update programs corresponding to the thread a and the thread A. Accordingly, the number of programs to be updated in accordance with a change in processing details is minimized, and thus a probability of a program bug occurring due to updating can be reduced.

Return to FIG. 14. By interprocess communication, the CPU substrate 601 receives, by a different process (process D), pieces of communication data that contain, as settings information, the gain value, the offset value, the noise cut level value and the maximum pulse number (step S1408: thread A). The pieces of communication data to be received here are the pieces of communication data generated by the thread b and the thread c, respectively.

The CPU substrate 601 analyzes the pieces of received communication data in accordance with, for example, the data structures as shown in FIG. 15 (step S1409: thread A). To be specific, first, data is read to “|”, and the data is recognized as information for specifying a command type that specifies a type of processing. Next, data is read from “|” to “:”, and the data is recognized as information for identifying a source thread and information for identifying a destination thread. If “,” is detected between “|” to “:”, the data from “|” to “,” is recognized as the information for identifying a source thread, and the data subsequent to “,” is recognized as the information for identifying a destination thread. If “,” is not detected, it is recognized that only the information for identifying a destination thread is present.

Next, data subsequent to “:” is read, and it is determined whether or not processing to be performed (i.e., command, property, event, etc) is stored in the CPU substrate 601 in advance. When it is determined that processing to be performed is stored in the CPU substrate 601 in advance, the separator “,” is searched, and each time the separator “,” is detected, data up to the detected separator “,” is recognized as information relating to corresponding processing.

In the example of FIG. 15(2), “SetDt” is recognized as a command; data from “=” to the separator “,” is recognized as the gain value; and data from the separator to the next separator “,” is recognized as the offset value.

Similarly, in the example of FIG. 15(3), “SetDt” is recognized as a command; data from“=” to the separator. “,” is recognized as the noise cut level value; and data from the separator to the next separator “,” is recognized as the maximum pulse number.

In the case of further adding data, for example, in the case of specifying a type of a band-pass filter to be selected by the thread c at the waveform signal processing substrate 603, the separator “,” may be further added so as to add data which indicates the type of a band-pass filter. In this case, the CPU substrate 601 simply recognizes the data up to the next separator “,” as a band-pass filter type, and thus there is no necessity to change the data structure of the communication data.

The CPU substrate 601 specifies destination threads, based on the information for identifying a destination thread, which information is contained in each piece of communication data (step S1410: thread A), and transfers, to the specified threads, the gain value, the offset value, the noise cut level value and the maximum pulse number which are pieces of settings information (step S1411: thread A). The CPU substrate 601 transmits the gain value and the offset value to the analogue substrate 602 as settings information (step S1412: thread B), and transmits the noise cut level value and the maximum pulse number to the waveform signal processing substrate 603 as settings information (step S1413: thread C). The analogue substrate 602 and the waveform signal processing substrate 603 each set the received settings information as configuration parameters.

As described above, according to the second embodiment, by containing, in the communication data, information for identifying a destination thread, a program which creates a thread for performing interprocess communication can be generalized. Accordingly, even if there occurs a change in contents of data to be transmitted/received as the communication data and program updating is caused, it is not necessary to update a program for interprocess communication. This makes it possible to reduce overall man-hours for program updating and reduce occurrences of bugs due to corrections in the program updating.

Further, by having the data structure as shown in FIG. 15, there is no necessity to update a program for interprocess communication even in the case where, for example, there is an item to be added to or to be deleted from contents of data to be transmitted/received as the communication data. This makes it possible to reduce overall man-hours for program updating and reduce occurrences of bugs due to corrections in the program updating.

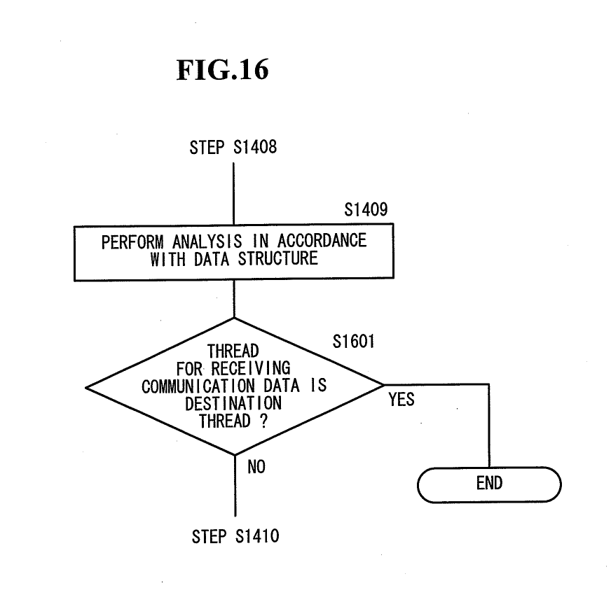

Still further, when the CPU substrate 601 receives the settings information (contained in the communication data) for setting communication specifications of interprocess communication, it is not necessary to transfer the received communication data. Here, the CPU substrate 601 may determine whether or not information for identifying a destination thread of the received communication data indicates a thread for directly receiving the communication data (thread A in the above example). FIG. 16 is a flowchart showing a sequence of processing performed by the CPU substrate 601 of the interprocess communication control device 6 in the case where the processing includes determination processing for the information for identifying a destination thread.

By interprocess communication, the CPU substrate 601 receives communication data which contains, as settings information, the gain value, the offset value, the noise cut level value and the maximum pulse number (step S1408: thread A), and analyzes the communication data in the same manner as that of the above-described embodiment (step S1409: thread A). Then, the CPU substrate 601 determines whether or not the information for identifying a destination thread indicates the thread A which is a thread for receiving the communication data (step S1601).

In the case where the CPU substrate 601 determines that the thread A for receiving the communication data is indicated (step S1601: YES), the CPU substrate 601 determines that the processing is to be completed in the thread A, and the processing ends without transferring the communication data. When the CPU substrate 601 determines that the thread A for receiving the communication data is not indicated (step S1601: NO), the processing proceeds to step S1410 and the above-described processing is performed.

As described above, by adding the processing for determining whether or not the information, for identifying a destination thread of the received communication data, indicates a thread for directly receiving the communication data (thread A in the above example), it can be determined whether or not the communication data is directed to the thread for directly receiving the communication data. In this manner, necessity or unnecessity of the transfer of the received communication data can be determined.

The above first and second embodiments are merely examples. Numerous other modifications and replacements can be devised without departing from the scope of the invention. It is understood that the present invention can be readily applied not only to an inspection device or an analyzer but also to various electronic devices which are capable of performing operation control by using interprocess communication.

What is claimed is:

1. An interprocess communication system for performing interprocess communication, comprising:
a transmission device; and
a reception device connected to the transmission device so as to be able to receive communication data via a network, wherein
in the transmission device,
a first process, to which a first thread and a plurality of other threads belong, is created, the first thread performing interprocess communication with outside and the plurality of other threads transferring the communication data to the first thread,
in the reception device,
a second process, to which a second thread and a plurality of other threads belong, is created, the second thread performing interprocess communication with outside and the plurality of other threads receiving the communication data transferred from the second thread, and
the first thread transmits, to the second thread, the communication data containing information for identifying a destination thread.

2. The interprocess communication system according to claim 1, wherein
the communication data has a data structure which contains information for identifying a type of the communication data, the information for identifying a destination thread, and transmission information divided by data separation information, and
the reception device transfers the communication data received by the second thread, to a thread indicated by the information for identifying a destination thread, which information is contained in the received communication data.

3. The interprocess communication system according to claim 2, wherein
the reception device determines whether or not the information for identifying a destination thread, which information is contained in the communication data received by the second thread, indicates the second thread, and when determining that the information for identifying a destination thread does not indicate the second thread, transfers the communication data to a thread indicated by the information for identifying a destination thread.

4. The interprocess communication system according to claim 1, further comprising
a measuring device connected to the reception device.

5. The interprocess communication system according to claim 4, wherein
the measuring device has a detection section for detecting a particle.

6. The interprocess communication system according to claim 5, wherein
the communication data contains settings information to be used for analyzing the particle detected by the detection section.

7. The interprocess communication system according to claim 6, wherein
the communication data has such a structure as to allow a number of pieces of the settings information to be changed.

8. An interprocess communication control device operable to transmit/receive communication data by interprocess communication, the interprocess communication control device comprising
a memory under control of a processor, the memory storing instructions enabling the processor to carry out operations comprising:
creating a first process to which a first thread and a plurality of other threads belong, the first thread transmitting the communication data to another process by interprocess communication and the plurality of other threads transferring the communication data to the first thread; and
creating a second process to which a second thread and a plurality of other threads belong, the second thread receiving the communication data from another process by interprocess communication and the plurality of other threads receiving the communication data transferred from the second thread, wherein
the first thread transmits, to the second thread, the communication data containing information for identifying a destination thread.

9. The interprocess communication control device according to claim 8, wherein
the communication data has a data structure which contains information for identifying a type of the communication data, the information for identifying a destination thread, and transmission information divided by data separation information, and
the operations further comprise transferring the communication data received by the second thread, to a thread indicated by the information for identifying a destination thread, which information is contained in the received communication data.

10. The interprocess communication control device according to claim 9, wherein
the operations further comprise determining whether or not the information for identifying a destination thread, which information is contained in the communication data received by the second thread, indicates the second thread, and
the transferring step is performed when the determining step has determined that the information for identifying a destination thread does not indicate the second thread.

11. The interprocess communication control device according to claim 8, further comprising
a data processing substrate for processing data transmitted from a measuring device.

12. The interprocess communication control device according to claim 11, wherein
the data processing substrate sets a configuration parameter based on the information contained in the communication data.

13. An interprocess communication control method operable to transmit/receive communication data by interprocess communication, the interprocess communication control method comprising:
transmitting the communication data from a first process to a second process, the first process having a first thread and a plurality of other threads belonging thereto, the first thread performing data transmission to another process by interprocess communication and the plurality of other threads transferring the communication data to the first thread, the second process having a second thread and a plurality of other threads belonging thereto, the second thread performing data reception from another process by interprocess communication and the plurality of other threads receiving the communication data transferred from the second thread; and
receiving the communication data by the second process, wherein
the first thread transmits, to the second thread, the communication data containing information for identifying a destination thread, and the second thread receives the communication data.

14. The interprocess communication control method according to claim 13, wherein
the communication data has a data structure which contains information for identifying a type of the communication data, the information for identifying a destination thread, and transmission information divided by data separation information,
the interprocess communication control method further comprising
transferring the communication data received by the second thread, to a thread indicated by the information for identifying a destination thread, which information is contained in the received communication data.

15. The interprocess communication control method according to claim 14, further comprising
determining whether or not the information for identifying a destination thread, which information is contained in the communication data received by the second thread, indicates the second thread, wherein
the transferring step is performed when the determining step has determined that the information for identifying a destination thread does not indicate the second thread.

16. A computer program product storing a computer program executable by a computer operable to transmit/receive communication data by interprocess communication, the computer program product comprising:
a computer readable medium; and
instructions on the computer readable medium, adapted to enable a general purpose computer to perform operations, comprising:
creating a first process to which a first thread and a plurality of other threads belong, the first thread transmitting the communication data to another process by interprocess communication and the plurality of other threads transferring the communication data to the first thread; and
creating a second process to which a second thread and a plurality of other threads belong, the second thread receiving the communication data from another process by interprocess communication and the plurality of other threads receiving the communication data transferred from the second thread, wherein
the first thread transmits, to the second thread, the communication data containing information for identifying a destination thread.

17. The computer program product according to claim 16, wherein
the communication data has a data structure which contains at least information for identifying a type of the communication data, the information for identifying a destination thread, and one or a plurality of pieces of transmission information divided by data separation information, and
the instructions further comprise transferring the communication data received by the second thread, to a thread indicated by the information for identifying a destination thread, which information is contained in the received communication data.

18. The computer program product according to claim 17, wherein
the instructions further comprise determining whether or not the information for identifying a destination thread, which information is contained in the communication data received by the second thread, indicates the second thread, and
the transferring step is performed when the determining step has determined that the information for identifying a destination thread does not indicate the second thread.

19. A computer program product storing a computer program executable by a computer operable to transmit communication data via a network by interprocess communication, the computer program product comprising:
a computer readable medium; and
instructions on the computer readable medium, adapted to enable a general purpose computer to perform operations, comprising:
creating a predetermined process to which a predetermined thread and a plurality of other threads belong, the predetermined thread transmitting the communication data to another process by interprocess communication and the plurality of other threads transferring the communication data to the predetermined thread; and
transmitting, from the predetermined thread to a thread belonging to said another process, the communication data containing information for identifying a destination thread.

20. The computer program product according to claim 19, wherein
the communication data has a data structure which contains at least information for identifying a type of the communication data, the information for identifying a destination thread, and one or a plurality of pieces of transmission information divided by data separation information.
